(19) United States
(12) Patent Application Publication
(10) Pub. No.: US 2004/0100555 A1
(43) Pub. Date: May 27, 2004

(54) Tanning bed with video player

(76) Inventor: James R. Foley, Mokena, IL (US)

Correspondence Address: James R. Foley, 19704 S. 114th Ave., Mokena, IL, 60448, US

(21) Appl. No.: 10/303,544

(22) Filed: Nov. 25, 2002

(51) Int. Cl. H04N 7/18; H04N 9/47

(52) U.S. Cl. 348/61

(57) ABSTRACT

A device which includes a tanning bed and video player. Additionally, a method of generating revenue using a tanning bed, where the method includes charging a customer to use the tanning bed, providing the customer with access to a video, and allowing the customer access to the tanning bed and a video player. Additionally, one may charge the customer a video rental fee.

### BACKGROUND

The present invention generally relates to tanning beds, and more specifically relates to a device for watching a video while tanning.

A lot of people use tanning beds. Some people even have one in their home. Others go to a tanning salon and pay to use a tanning bed. Tanning beds generally come in two forms—lay down or stand up. A lay down bed is a horizontal bed having a lower portion on which a tanner lays and an upper portion which lowers and raises relative to the lower portion. Stand up beds generally take the form of capsules in which a person stands.

While using a tanning bed is considered by most people to be a peaceful experience, it is also boring. As such, a lot of people listen to music while using a tanning bed. Listening to music while tanning does alleviate some of the boredom, it typically does not alleviate all boredom.

### OBJECTS AND SUMMARY

A general object of an embodiment of the present invention is to provide a device for watching a video while tanning.

Briefly, and in accordance with at least one of the foregoing objects, an embodiment of the present invention provides a device which includes a tanning bed and video player.

Another embodiment of the present invention provides a method of generating revenue using a tanning bed, where the method includes charging a customer to use the tanning bed, providing the customer with access to a video, and allowing the customer access to the tanning bed and a video player. Additionally, one may charge the customer a video rental fee.

### BRIEF DESCRIPTION OF THE DRAWINGS

The organization and manner of the structure and operation of the invention, together with further objects and advantages thereof, may best be understood by reference to the following description, taken in connection with the accompanying drawing, wherein:

FIG. 1 is a side view of a lay down-type, horizontal tanning bed which is in accordance with an embodiment of the present invention;

FIG. 2 is a front view of the tanning bed shown in FIG. 1;

FIG. 3 is a view of a portion of an interior wall of a stand up-type, or capsule tanning bed which is in accordance with an embodiment of the present invention;

FIGS. 4a and 4b are front views of DVD player and head mounted display combinations which can be used in connection with the tanning beds shown in FIGS. 1-3;

FIG. 5 is a side view of a lay down-type, horizontal tanning bed which is in accordance with an alternative embodiment of the present invention;

FIG. 6 is a view of a portion of an interior wall of a stand up-type, or capsule tanning bed which is in accordance with an alternative embodiment of the present invention.

### DESCRIPTION

While the invention may be susceptible to embodiment in different forms, there are shown in the drawings, and herein will be described in detail, specific embodiments with the understanding that the present disclosure is to be considered an exemplification of the principles of the invention, and is not intended to limit the invention to that as illustrated and described herein.

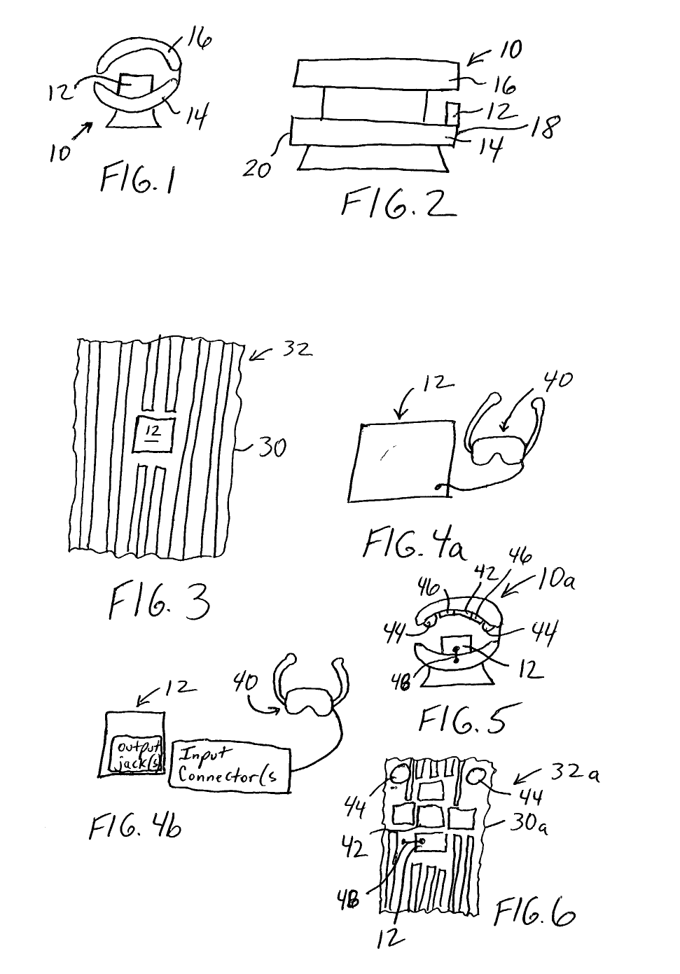

FIGS. 1 and 2 illustrate a device which is in accordance with an embodiment of the present invention. Specifically, FIGS. 1 and 2 illustrate a lay down-type, horizontal tanning bed 10 and a video player 12, for example a DVD player, which is either integral with or connected to the tanning bed 10. The tanning bed 10 includes a lower portion 14 on which a user or tanner lays when using the bed, and an upper portion 16 which raises and lowers relative to the lower portion 14. As shown in FIG. 2, the tanning bed 10 includes a head end 18, proximate which a user positions his or her head when using the tanning bed, and a foot end 20 proximate which a user positions his or her feet while using the tanning bed. As shown in FIG. 2, preferably, the video player 12 is proximate the head end 18 of the tanning bed, thereby providing that the user can easily access any controls associated with the video player 12.

FIG. 3 illustrates a device which is in accordance with another embodiment of the present invention. Specifically, FIG. 3 illustrates a portion of an interior wall 30 of a stand up-type, upright tanning bed (i.e., capsule) 32. As shown, the tanning bed includes a video player 12, for example a DVD player, which is either integral with or connected to the tanning bed 32.

Regardless of whether the device is provided as a lay down-type or stand up-type tanning bed, preferably, the video device 12 is provided as shown in FIG. 4a or 4b. FIG. 4a illustrates a video device 12, such as a DVD player, which is hard-wired or permanently connected to a head mounted display 40, while FIG. 4b illustrates a video device 12, such as a DVD player, which has one or more output jack(s) for receiving one or more corresponding input connectors of a head mounted display 40.

In either case, the head mounted display 40 is preferably of the type which provides both video and audio to the user in the form of a pair of goggles. Such head mounted displays are known in the art and are currently commercially available under the mark “i-Scape” from i-O Display Systems, 1338 N. Market Boulevard, Sacramento, Calif. 95834 (916-928-9639). Web sites which offer i-Scape brand head mounted displays for sale include www.i-glasses.com, www.i-glassesstore.com and www.vrealities.com.

FIGS. 5 and 6 illustrate alternative embodiments. Like FIGS. 1 and 2, FIG. 5 illustrates a lay down-type, horizontal tanning bed 10a and a video player 12, for example a DVD player, which is either integral with or connected to the tanning bed 10a. However, in FIG. 5, the tanning bed includes a video display 42 and speakers 44 which are integral with the bed 10a and connected to the video player 12 (line 48 represents connections between the video player 12 and the video display 42 and speakers 44). As such, there is no need to use a head mounted display. As shown in FIG. 5, facial tanners 46 may be disposed proximate the video display.

Like FIG. 3, FIG. 6 illustrates a portion of an interior wall 30a of a stand up-type, upright tanning bed (i.e., capsule) 32a which includes a video player 12, such as a DVD player. However, in FIG. 6, the tanning bed 32a includes a video display 42 and speakers 44 which are integral with the bed and connected to the video player 12 (line 48 represents connections between the video player 12 and the video display 42 and speakers 44). As such, there is no need to use a head mounted display. As shown, facial tanners 46 may be disposed proximate the video display 42.

Another embodiment of the present invention provides a method of generating revenue using a tanning bed by charging a customer to use the tanning bed, providing the customer with access to a video, tanning bed and video player. Any of the devices shown in the FIGURES can be used in connection with practicing such a method. Further, one may charge the customer a video rental fee. Additionally, one may provide the customer with access to a head mounted display, and may charge the customer for the access (i.e., a rental fee).

While embodiments of the present invention are shown and described, it is envisioned that those skilled in the art may devise various modifications of the present invention without departing from the spirit and scope of the appended claims.

What is claimed is:

1. A device for watching a video while tanning, said device comprising; a tanning bed; a video player on the tanning bed; and a head mounted display connected to the video player.

2. A device as recited in claim 1, wherein the video player comprises a DVD player.

3. A device as recited in claim 1, wherein the video player is integral with the tanning bed.

4. A device as recited in claim 1, wherein the video player is connected to the tanning bed.

5. A device as recited in claim 1, wherein the tanning bed is a horizontal, lay down tanning bed.

6. A device as recited in claim 1, wherein the tanning bed is an upright, tanning capsule.

7. A device as recited in claim 1, wherein the head mounted display is hard-wired to the video player.

8. A device as recited in claim 1, wherein the head mounted display includes at least one input connector and said video device includes at least one corresponding output jack for receiving the at least one input connector of the head mounted display.

9. A device as recited in claim 1, wherein said tanning bed has a head end and a foot end and said video player is disposed proximate the head end of the tanning bed.

10. A device for watching a video while tanning, said device comprising; a tanning bed; a video player integral with the tanning bed; a video display integral with the tanning bed and connected to the video player; and at least one speaker integral with the tanning bed and connected to the video player.

11. A device as recited in claim 10, wherein the tanning bed includes at least one facial tanner, said facial tanner proximate said video display.

12. A method of generating revenue using a tanning bed comprising: charging a customer to use the tanning bed; providing the customer with access to a video; and allowing the customer access to the tanning bed and a video player.

13. A method as recited in claim 12, further comprising charging the customer a video rental fee.

14. A method as recited in claim 12, further comprising providing the customer with access to a head mounted display.

15. A method as recited in claim 14, further comprising charging the customer a fee in association with providing the customer with access to the head mounted display.
